(19) United States
(12) Patent Application Publication
(10) Pub. No.: US 2018/0124184 A1
(43) Pub. Date: May 3, 2018

(54) COMPREHENSIVE URBAN COMMUNICATIONS, DATA GATHERING AND AGGREGATION ARRAY

(71) Applicants: Shannon Champion, Newburgh, IN (US); Michael Keller, Evansville, IN (US); Arthur Chlebowski, Evansville, IN (US)

(72) Inventors: Shannon Champion, Newburgh, IN (US); Michael Keller, Evansville, IN (US); Arthur Chlebowski, Evansville, IN (US)

(21) Appl. No.: 15/792,622

(22) Filed: Oct. 24, 2017

Related U.S. Application Data
(60) Provisional application No. 62/414,762, filed on Oct. 30, 2016.

(51) Int. Cl. H04L 29/08; H04W 4/00; H04W 84/22

(52) U.S. Cl. CPC H04L 67/125; H04W 4/008; H04W 84/22; H04W 4/006

(57) ABSTRACT

A system comprising of aggregated public safety devices, where each device may contain sensors and communication platforms used to collect data of entities near the system. Further, each device can communicate with one another or other third-party entities relaying system information.

### CROSS-REFERENCE TO RELATED APPLICATION

This application claims priority to U.S. Provisional Application Ser. No. 62/414,762 filed Oct. 30, 2016, and titled Comprehensive Urban Communications, data gathering and aggregation array, the contents of which are incorporated herein by reference.

### BACKGROUND

### Technical Field

Platform integrated system that allows the interaction and transfer of information across many sensors peripherals and digital and analog data transmission related to public monitoring and public safety.

### Description of the Related Art

Whether referred to as Internet of Things (IoT), Cyber-Physical Systems (CPS), Machine to Machine (M2M) technologies, Industrial Internet, or Smart Cities; all of these efforts aim to improve society through the harnessing of data, information, and resources from an array of sensors, devices, and systems. In China it was reported that there were 9 billion devices in 2014, with estimates of 24 billion by 2020. This is part of the 50 billion network devices that are estimated globally by the year 2020. These devices range from personal biometric measurements and targeted street-level monitoring to large-scale Smart Grid events within city, regional and national decision levels for critical decision-making.

Along with a wealth of existing sensor technologies, new devices and computational techniques are developed that provide sources of data that were previously not available. Data generating devices are typically either collections of one or more sensors and components intended for standalone functions, such as a hand held radiation detector, or hardware that is dependent on higher-level hardware or software for data acquisition. Hardware dependencies range from low-level analog to digital controllers (ADC) to high-level IoT gateways. A number of software platforms have been developed to manage data from standalone, devices, low-level sensors, and IoT gateways in support large-scale IoT data collection. However, the majority of existing platforms rely on public cloud providers such as Amazon EC2 and Microsoft Azure for backend services, requiring the movement of data from sources of collection to remote data centers for processing.

### SUMMARY OF THE DISCLOSURE

Existing data generation and collection systems focused on local data collection and remote data processing. In addition, current systems are not intended for programmable infrastructure and you can't control where processing occurs or what paths are taken for network communication.

We propose a system and platform that provides data generation, communication, and processing capabilities through a modular sensor platform, combined with localized computational and network resources. The system is intended but not limited to use as part of a collection of systems to form a complex distributed data collection and processing environment.

### BRIEF DESCRIPTION OF THE DRAWINGS

Not all components may necessarily be explicitly illustrated in the drawings. Components of one device may be adapted with components of other devices illustrated in this document and that concepts may be interchangeably moved from one disclosed device to another and visa versa. For a more complete understanding of the disclosed methods and apparatuses, reference should be made to the embodiments illustrated in greater detail in the accompanying drawings, where in:

FIG. 1: Device 101—Illustration of sensor array platform. The sensor array system encompassing one or a multitude of sensor and networking components to monitor and report activity.

FIG. 2: Device 106—Illustration of connection scheme of local compute. FIG. 2 collectively connects a singular sensor array or multitude of sensor arrays to a local compute cluster for analysis and communication. Further this local compute and sensor array is powered through existing capabilities such as existing power lines, solar, POE or energy storage.

FIG. 3: Device 108—Illustration of aggregation of local computes FIG. 3 illustrates the integration of several local computes to an aggregated level as was discussed in the citywide and regional hierarchy.

FIG. 4: Device 111—Illustration of high level compute and control FIG. 4 illustrates an increased number of components and systems integrating into a larger scale aggregation. This can be observed in the regional hierarchy. Further described in this illustration is the capability of monitoring and control by local or remote location. This capability can be introduced in any of the levels within the described hierarchy.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE PRESENTLY PREFERRED

### Embodiments

The proposed system demonstrates many characteristics inherent to edge computing and must address the following edge computing challenges:
1. Low latency and location awareness: Processing of data streams, especially for real-time events and/or time-synchronized data enrichment, must be performed as close to the source of data as possible. For example, the detection of critical sensor data must be correlated locally and communicated globally as soon as possible. Long-distance network transfers required in remote processing introduces alert latency, which can directly impact response times to both safety responders and perhaps more importantly to real-time destinations such as anti-collision systems in vehicles. Likewise, time-series data from devices and associated sensors must maintain location information. Many data sources will provide location information as part of their data payload, while other sources must be enriched with location information as close to the data source as possible, for the aforementioned reasons.
2. Widespread geographical distribution: The system aims to make use of sensor data and other associated data streams across wide geographic areas. While computational resources might not exist on the edge network of all sensor deployments, network configuration and computational load factors will make the assignment of data sources to some system resources more appropriate than others. The system could have the capability to determine the most appropriate system resource(s) based on a geographic view of available resources and evaluate assignments over time.
3. Very large number of nodes: Even for medium-sized cities the potential exist for managing data from millions of devices. The system has been developed with the ability to address many potential sources of data.
4. Mobility: There exist many fixed-location data sources, such as sensors attached to buildings, street post, doors, etc. However, many more data sources exist from mobile sources such as vehicular cameras, drones, and personal devices. The system is designed to directly communicate with all of these devices, and as previously mentioned be aware of these mobile data source and their locations.
5. Strong presence of streaming and real-time applications: Video and other associated time-series data collection services are inherently streaming applications. The system must be able to manage streams of data through dynamic assignment of workloads from a distributed computational resources. In addition, the system's resources must be able to process and respond directly to location-aware queries in a pseudo real-time manner. As a result, the system's edge devices must be able to perform antonymous real-time operations without the need for central coordination or interaction.
6. Heterogeneity: The system must be able to contend with a wide range of data source formats, communication protocols, and diverse performance profiles. In addition, the system must observe and react to changes in performance in relation to workload assignments and inherent network and communication capabilities.

The system is intended to operate in a distributed agent-based edge-computing framework, as part of a decentralized (hierarchical) resource management system. The control system provides component-level configuration management, measurement of component-level metrics, and antonymous service-level runtimes for system components. Making use of the described platform, we have developed a collection of modules for common tasks such as optimization of the resource assignments, data processing, data redistribution, and application resiliency.

Management applications utilizing a hierarchy of resources from independent system providers and heterogeneous data sources will also be integrated with the system. With this framework, we will be able to take stock of the present state of a complete system. In addition, using this agent-based framework we can manage a hierarchy of resources that either have no common control framework, or are otherwise unreachable due to communication constraints.

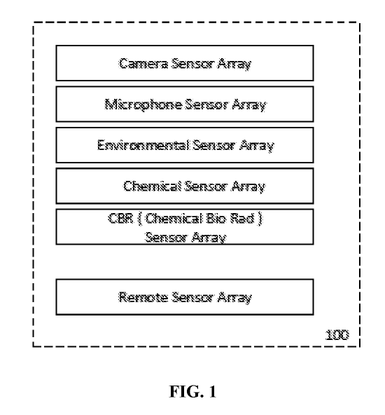

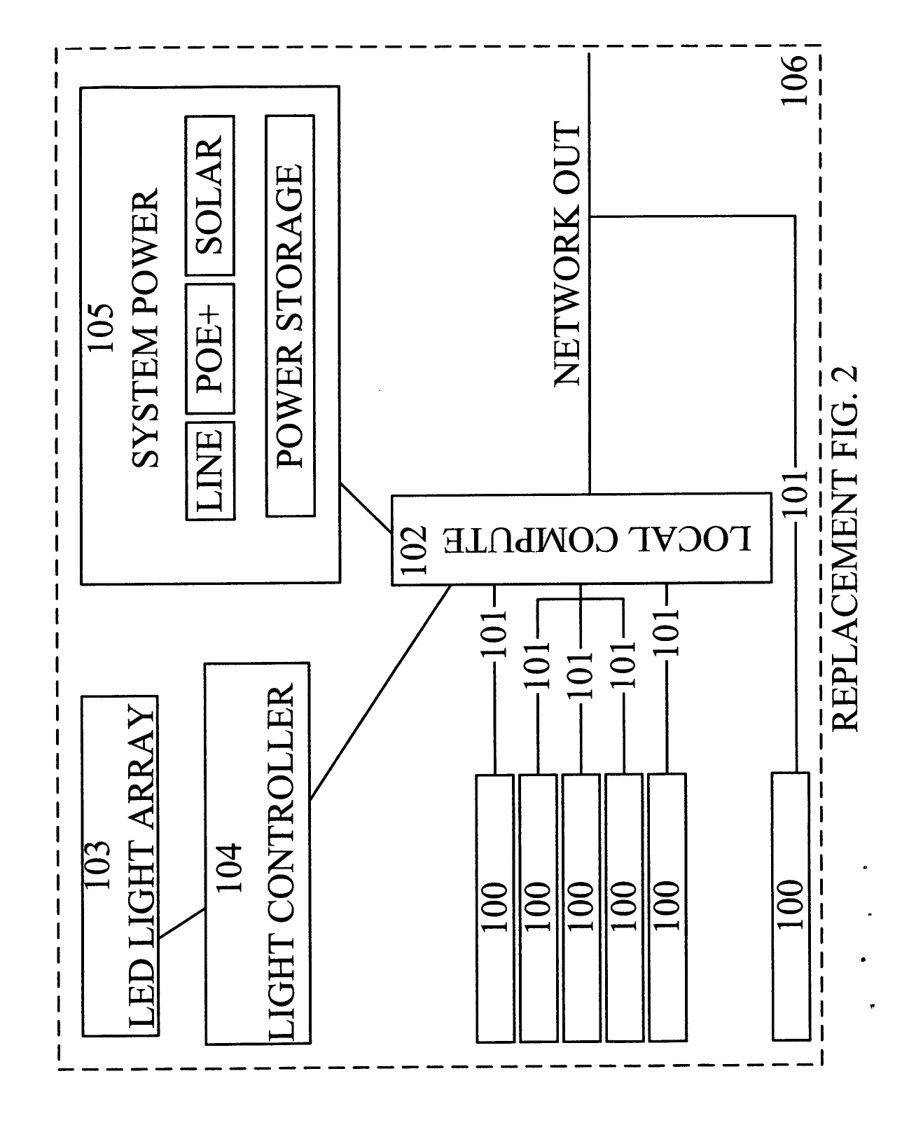

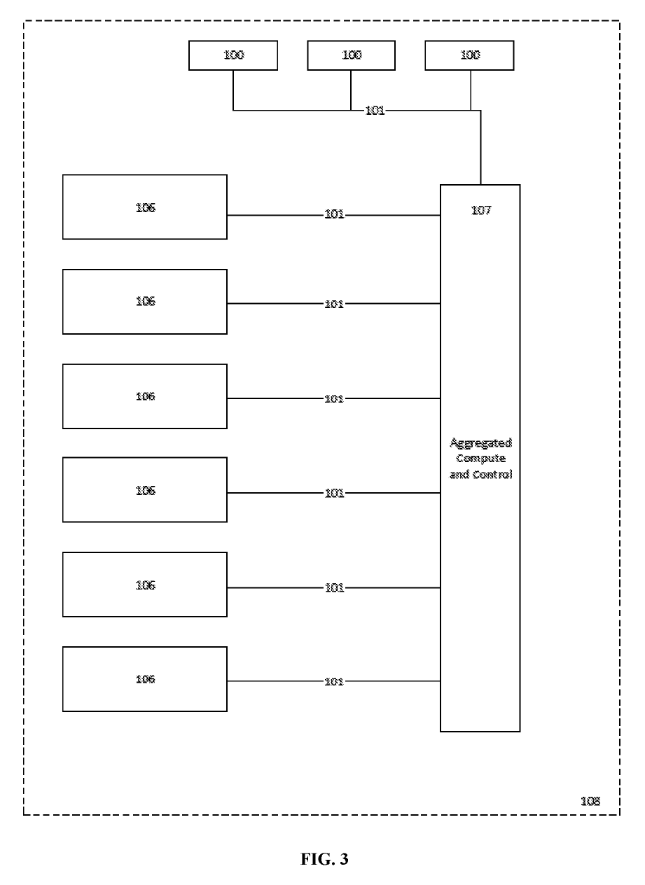

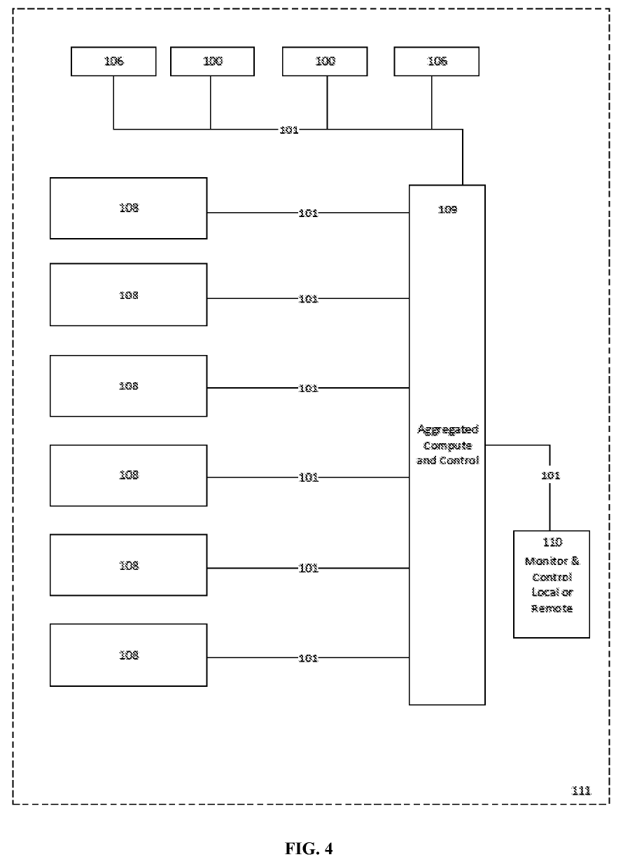

The system's environment is arranged in a hierarchy of three levels:
1. Agent: Individual system instance providing computational, network, and data resources (FIGS. 1 and 2)
2. City: Central coordination of distributed resource state including scheduling, reporting, and citywide control interfaces (FIG. 3).
3. Regional: Regional control of resources, typically representative of a geographic collection location (FIGS. 3 and 4).
4. Agent-Plugin: Workload implementation managed by an Agent, representing sensor data sources, external resource interfaces, and local programmatic implementations. Plugins provide application-level metrics and environment-level observation and discovery information. (FIG. 4)

It is to be understood that the description is intended to illustrate and not to limit the scope of the invention, which is defined by the scope of the claims.

What is claimed is:

1. A method or system using multiple sources to identify interests based on feedback from at least one content source, and inform the system or systems on identified interests, through use of autonomous or semi-autonomous data collection, aggregation, and measurement platforms.

2. The method of claim 1, wherein the content source can be a chemical, biological, radiological, radio frequency, audio, visual, or temperature sensor.

3. The method of claim 1, wherein the content source can be communication capabilities including but not limited to Bluetooth, WiMax, LiFi, WiFi, cellular, or other public safety frequencies.

4. The method of claim 1, wherein energy is supplied can be battery or power storage, line or existing power grid, renewable energy sources, or power over ethernet.

5. The method of claim 1, wherein the system may contain decision making capabilities.

6. The method of claim 1, wherein data or information can be stored.

7. The method of claim 1, wherein a system or systems can communicate via wired or wireless methods either internally or with outside sources.

8. The method of claim 1, wherein the system may contain an interface

9. A method or system of claim 1 further comprising:
a plurality of systems in aggregation

10. The method of claim 9, wherein the content source can be a chemical, biological, radiological, radio frequency, audio, visual, or temperature sensor.

11. The method of claim 9, wherein the content source can be communication capabilities including but not limited to Bluetooth, WiMax, LiFi, WiFi, cellular, or other public safety frequencies.

12. The method of claim 9, wherein energy is supplied can be battery or power storage, line or existing power grid, renewable energy sources, or power over ethernet.

13. The method of claim 9, wherein the system may contain decision making capabilities.

14. The method of claim 9, wherein data or information can be stored.

15. The method of claim 9, wherein a system or systems can communicate via wired or wireless methods either internally or with outside sources.

16. The method of claim 9, wherein the system may contain an interface.
